(19) United States
(12) Patent Application Publication
(10) Pub. No.: US 2025/0088300 A1
(43) Pub. Date: Mar. 13, 2025

(54) WAVELENGTH DIVISION MULTIPLEXING SHUFFLE BOX FOR OPTICALLY CONNECTING DEVICES

(71) Applicant: MELLANOX TECHNOLOGIES, LTD., Yokneam (IL)

(72) Inventors: Barak Gafni, Sunnyvale, CA (US); Henning Lysdal, Roskilde (DK)

(21) Appl. No.: 18/367,970

(22) Filed: Sep. 13, 2023

(51) Int. Cl. H04J 14/02; H04Q 11/00

(52) U.S. Cl. CPC H04J 14/0307; H04Q 11/0062; H04Q 2011/0088

(57) ABSTRACT

A system for distributing individual wavelength signals to different destinations. The system includes three or more optical connectors, wherein fibers connected to the three or more optical connectors carry a plurality of wavelength signals. The system also includes a device that routes a first optical signal having a first wavelength from a first optical connector to a second optical connector.

### FIELD OF THE INVENTION

The present disclosure relates generally to systems and methods of providing optical communication between devices, and particularly to the scalability of network interfaces using wavelength division multiplexing (WDM) optics.

### BACKGROUND

Data centers that handle substantial amounts of data commonly utilize devices such as high-capacity switches and/or servers. These devices send and receive data to and from multiple other devices and/or network locations. Such devices may include one or more application-specific integrated circuits (ASICs). The ASICs in each device connect to one or more interfaces on a panel of the device. Via these interfaces, the ASICs of each device are enabled to communicate with other, external devices. Communication between devices should be as lossless and as fast as possible, for example at data rates reaching hundreds of Tb/s.

### BRIEF SUMMARY

Embodiments of the present disclosure that are described herein provide systems, devices, and methods for distributing individual wavelength signals to different destinations. In embodiments, individual wavelength signals of a wavelength division multiplexing (WDM) signal may be transmitted between devices within a system, such as a switch, server, or other electrical device, and interfaces or ports on an external panel of the system. Such internal connections provide for greater communication efficiency, fewer required cables between systems, and other benefits.

Using a connection system as described herein, optical signals may be received and distributed over a plurality of wavelengths. The connection system includes multiple optical connectors configured to demultiplex/multiplex WDM signals.

In a disclosed embodiment, a device comprises an ASIC or other processing device each connected to each of one or more optical interfaces such as a 400GBASE-FR4 module. Each ASIC receives light of a different wavelength from a respective light source such as an external laser source (ELS) or from a light or laser source embedded as part of an ASIC package or on a same board as the ASIC. Each light source may provide a stream of light (e.g., a constant stream of light or continuous wave) to one or more electrical-to-optical (E-O) converter(s) in the ASIC package or on a same board as the ASIC package. Each ASIC, for example with one or more E-O converters, may modulate a signal onto this stream of light. In this way, each ASIC may output data onto an optical fiber using the received light at the same wavelength as received. The data output by each ASIC may be received by an optical interface. The optical interface may multiplex the received signals from each ASIC such that the system may be connected to a network device via a single optical fiber carrying data to and/or from each ASIC.

It should be appreciated that any one of the disclosed embodiments may be implemented in combination with any one or more other embodiments, any one or more of the features disclosed herein, any one or more of the features as substantially disclosed herein, any one or more of the features as substantially disclosed herein in combination with any one or more other features as substantially disclosed herein, any one of the aspects/features/embodiments in combination with any one or more other aspects/features/embodiments, use of any one or more of the embodiments or features as disclosed herein. It is to be appreciated that any feature described herein can be claimed in combination with any other feature(s) as described herein, regardless of whether the features come from the same described embodiment.

Additional features and advantages are described herein and will be apparent from the following description and the figures.

### BRIEF DESCRIPTION OF THE DRAWINGS

The present disclosure will be more fully understood from the following detailed description of the embodiments thereof, taken together with the drawings in which:

FIG. 1 illustrates an example configurations of a shuffle box for distributing individual wavelength signals to different destinations in accordance with the present disclosure;

FIGS. 2A-2B illustrate various alternative configurations of a shuffle box for distributing individual wavelength signals to different destinations in accordance with the present disclosure;

FIG. 3 is a flowchart of a method of distributing individual wavelength signals to different destinations in accordance with the present disclosure; and

FIG. 4 illustrates an example system for distributing individual wavelength signals to different destinations in accordance with aspects of the present disclosure.

### DETAILED DESCRIPTION OF EMBODIMENTS

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or optical links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The terms “determine,” “calculate,” and “compute,” and variations thereof, as used herein, are used interchangeably and include any appropriate type of methodology, process, operation, or technique.

Various aspects of the present disclosure will be described herein with reference to drawings that may be schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “include,” “including,” “includes,” “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

The present disclosure relates to the scalability of network interfaces using wavelength division multiplexing (WDM) optics. WDM optics are becoming more important as more bandwidth is required within data centers, as a single fiber can carry multiple lambdas (e.g., wavelengths), so each fiber can carry more signals increasing bandwidth compared to a parallel approach (e.g., single signal on each connection). A system using WDM optics needs to manage how to send distribute the individual lambdas carried over one fiber towards different destinations. The present disclosure allows enlargement of the effective radix of a networking element (e.g., a switch), and allows the cluster in a data center to scale better, with less power and cost.

Using a parallel approach (e.g., DR4) a breakout can be made by sending different fibers to different destinations, once multiple lambdas are being carried over a single fiber there is a need to distribute the lambdas, hence need for a different solution to ensure that the right wavelengths are eventually being aggregated together in the right form.

The present disclosure is directed to a dedicated system solution with multiple optical connectors that may shuffle lambdas (e.g., individual wavelength signals) between the optical connectors. For example, the system may take a pair of input fibers, demultiplex the WDM signals on each input fiber into individual lambdas, distribute the individual lambdas to output connectors, which then multiplex the individual lambdas back into a WDM signal to be transferred over a pair of output fibers. The shuffle box of the present disclosure uses the minimum hardware needed to perform this operation (reducing cost and complexity), and the individual lambdas only need to go through the system once (e.g., single processing).

A switch assembly may be contained in a rack-mounted case, with optical receptacles on its front panel for ease of access. The signals from and to the ASIC are conveyed to and from the optical receptacles using optical fibers. Space constraints of the switch and the front panel may limit the number of optical fibers connected to the ASIC and optical receptacles on the panel. Therefore, the optical signals emitted and received by the switch are multiplexed using wavelength division multiplexing, so that each fiber, along with the associated optical receptacle, carries multiple optical signals. For example, each fiber may carry four channels of 100 Gb/s each, at four different, respective wavelengths, to and from the corresponding optical receptacle, for a total data rate of 400 Gb/s (denoted as 4×100 Gb/s).

The multiple communication channels carried at different wavelengths on the same fiber may be directed to and from different network nodes. For example, each of the 100 Gb/s component signals on a 4×100 Gb/s optical link may be directed to a different server. What is needed is a connection system capable of connecting one or more ASICs or other processing devices within a system such as a server or switch with one or more optical interfaces. As described herein, each ASIC may output data at a different wavelength to one or more optical interfaces. Each optical interface may be capable of outputting multiplexed data from a plurality of processing devices.

Although the description herein, for the sake of simplicity, refers to transmission of signals from a system to a network node, in embodiments of the present invention, an optical cable may be configured for transmitting wavelength division multiplexed signals in two directions between the system and the node. In such embodiments, the optical fibers may comprise four fiber pairs (rather than four single fibers).

Embodiments of the present disclosure may be configured as follows:

(1) A system for distributing individual wavelength signals to different destinations, the system comprising: three or more optical connectors, wherein fibers connected to the three or more optical connectors carry a plurality of wavelength signals; and a device that routes a first optical signal having a first wavelength from a first optical connector to a second optical connector.
(2) The system of (1), wherein the device routes a second optical signal having a second wavelength from the first optical connector to a third optical connector.
(3) The system of one or more of (1) and (2), wherein the first wavelength is different from the second wavelength.
(4) The system of one or more of (1) to (3), wherein the three or more optical connectors comprise a Lucent Connector (LC).
(5) The system of one or more of (1) to (3), wherein the three or more optical connectors comprise a Multi-fiber push on (MPO) connector,
(6) The system of one or more of (1) to (4), wherein the first optical connector connects to a first network device and the second optical connector connects to a second network device.
(7) The system of one or more of (1) to (5), wherein the first network device is in a first layer of a network and the second network device is in a second layer of the network that is different from the first layer of the network, a third processing device to output a third optical signal using a third wavelength different from the first wavelength and the second wavelength; and at least a fourth processing device to output at least a fourth optical signal using a wavelength different from the first wavelength, the second wavelength, and the third wavelength.
(8) The system of one or more of (1) to (6), wherein the first network device and the second network device comprise a switch.
(9) The system of one or more of (1) to (7), wherein the plurality of wavelength signals comprise a wavelength division multiplexing (WDM) signal comprising four different wavelengths signals.
(10) The system of one or more of (1) to (8), wherein the second connector multiplexes at least two optical signals of different wavelengths.
(11) A method of distributing portions of a wavelength division multiplexing (WDM) signal to different destinations, the method comprising: receiving via a first optical connector a WDM signal from a first network device, wherein the WDM signal comprises a plurality of wavelength signals; separating, via an optical demultiplexer the WDM signal into a plurality of optical signals; and routing and multiplexing via a device a first optical signal having a first wavelength and a second optical signal having a second wavelength from the first optical connector to a second optical connector, and a third optical signal having a third wavelength and a fourth optical signal having a fourth wavelength from the first optical connector to a third optical connector. (12) The method of (11), wherein the first optical connector, the second optical connector, and the third optical connector comprise a Lucent Connector (LC).
(13) The method of one or more of (11) to (12), wherein the first optical connector connects to the first network device and the second optical connector connects to a second network device, wherein the first network device is in a first layer of a network, and wherein the second network device is in a second layer of the network that is different from the first layer.
(14) The method of one or more of (11) to (13), wherein the first network device and the second network device comprise a network switch.
(15) The method of one or more of (11) to (14), wherein the WDM signal comprises four different wavelength signals.
(16) A device for distributing individual wavelength signals to different destinations, the device comprising: three or more optical connectors, wherein fibers connected to the three or more optical connectors carry a plurality of wavelength signals; and a control that routes a first optical signal having a first wavelength from a first optical connector to a second optical connector.
(17) The device of (16), wherein the control routes a second optical signal having a second wavelength from the first optical connector to a third optical connector.
(18) The device of one or more of (16) to (17), wherein the three or more optical connectors comprise a Lucent Connector (LC) or a Multi-fiber push on (MPO) connector.
(19) The device of one or more of (16) to (18), wherein the first optical connector connects to a first network device and the second optical connector connects to a second network device, and wherein the first network device is in a first layer of a network and the second network device is in a second layer of the network that is different from the first layer of the network.
(20) The device of one or more of (16) to (19), wherein the first network device and the second network device comprise a switch.
(21) The device of one or more of (16) to (20), wherein the plurality of wavelength signals comprise a wavelength division multiplexing (WDM) signal comprising four different wavelengths signals.
(22) A system for distributing individual wavelength signals of a wavelength division multiplexing (WDM) signal to different destinations, the system comprising: a first optical connector to receive a first WDM signal from a first network device and divide the first WDM signal into a first pair of optical signals and a second pair of optical signals; a second optical connector to receive a second WDM signal from a second network device and divide the second WDM signal into a third pair of optical signals and a fourth pair of optical signals; a third optical connector to receive and multiplex the first pair of optical signals and the third pair of optical signals into a third WDM signal and transfer the third WDM signal to a third network device; and a fourth optical connector to receive and multiplex the second pair of optical signals and the fourth pair of optical signals into a fourth WDM signal and transfer the fourth WDM signal to a fourth network device.
(23) The system of (22), wherein the first optical connector, the second optical connector, the third optical connector, and the fourth optical connector comprise a Lucent Connector (LC).
(24) The system of one or more of (22) to (23), wherein the first network device and the second network device are in a first layer of a network, and wherein the third network device and the fourth network device are in a second layer of the network that is different from the first layer of the network.
(25) The system of one or more of (22) to (24), wherein the first WDM signal, the second WDM signal, the third WDM signal, and the fourth WDM signal each comprise four different wavelengths signals.
(26) The system of one or more of (22) to (25), wherein the first pair of optical signals comprises a first optical signal on a first wavelength and a second optical signal on a second wavelength, and wherein the third pair of optical signals comprises a third optical signal on a third wavelength, and a fourth optical signal on a fourth wavelength.
(27) The system of one or more of (22) to (26), wherein the second pair of optical signals comprises a fifth optical signal on the third wavelength and a sixth optical signal on the fourth wavelength, and wherein the fourth pair of optical signals comprises a seventh optical signal on the first wavelength, and an eighth optical signal on the second wavelength.
(28) The system of one or more of (22) to (27), further comprising: a fifth optical connecter that separates the first WDM signal into separate optical signals for each wavelength; and a sixth optical connector that separates the second WDM signal into separate optical signals for each wavelength.
(29) The system of one or more of (22) to (28), further comprising: a seventh optical connector that multiplexes the first pair of optical signals and the third pair of optical signals into the third WDM signal; and an eighth optical connector that multiplexes the second pair of optical signals and the fourth pair of optical signals into the fourth WDM signal.
(30) The system of one or more of (22) to (29), wherein the fifth optical connector, the sixth optical connector, the seventh optical connector, and the eighth optical connector comprises a waveguide.

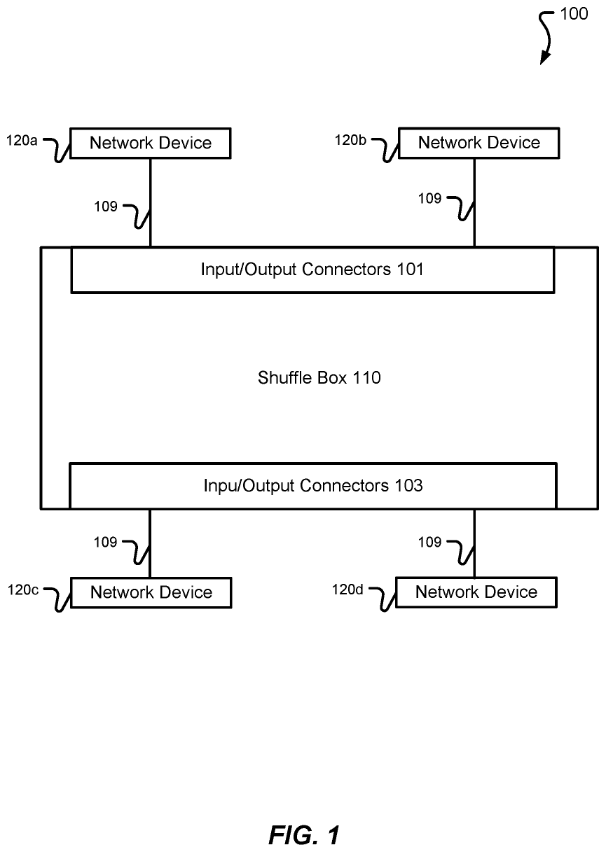

FIG. 1 illustrates a system 100 comprising a shuffle box 110 that includes one or more input connectors 101 and 103 (e.g., the input connectors 101 and 103 may comprise two or more input/output connectors 101 and 103), and network devices 120a-d. The input/output connectors 101 and 103 receive and transmit signals depending on the direction of the signal. In embodiments, the connectors 101 and 103 may comprise Lucent Connectors (LC).

In the example illustrated in FIG. 1, the connectors 101 and 103 are connected with external optical cables 109 to network devices 120a-d. The optical connectors 101 and 103 may be capable of demultiplexing WDM signals into individual wavelength signals, and multiplexing individual wavelength signals into respective WDMs signals. In embodiments, the shuffle box 110 may demultiplex incoming WDM signals into individual wavelength signals, and multiplex individual wavelength signals into respective WDMs signals. The WDM signals are received from/transmitted to respective network devices 120a-d via fibers 109. Furthermore, optical cables 109 of the sort in accordance with embodiments of the present disclosure may be used not only in this sort of connections between systems such as switches and servers, but also in other applications in which network nodes are connected using optical wavelength multiplexing. Each optical fiber cable 109 may comprise one or more optical fibers. Each optical fiber is capable of receiving and carrying an optical signal. The optical signal may be a four-wavelength signal such as a 400GBASE-FR4 and operate at, for example, 400 Gb/s with four lanes, each at 100 Gb/s.

It should be appreciated that the systems and methods described herein may be used with FR4 interfaces as well as any other form of interface. The present disclosure is intended to cover any type of high-speed pluggable interface and may assume any suitable type of known or yet-to-be developed form factor, such as which may be capable solely of hosting an optical connector. The systems and methods described herein may be used in relation to any form of optical signals sent using any type of protocol relating to, for example, WDM, coarse wavelength division multiplexing (CWDM), dense wavelength division multiplexing (DWDM), 400GBASE-FR4, 400GBASE-DR4, 400GBASE-SR4.2, etc., or any combination thereof.

Each optical connector 101 and 103 may be capable of outputting data onto a single optical fiber 109 using multiple lanes. For example, an interface may utilize CWDM technology to output a plurality of lanes of data onto one strand of fiber. In some embodiments, an interface may utilize DWDM to output a plurality of lanes of data onto a single strand of fiber. Each lane of data may be spaced by, for example, 0.4 nm, 0.8 nm, 20 nm, etc., depending on the technology being used to output data. For example, CWDM may utilize 20 nm while DWDM may utilize 0.4 or 0.8 nm.

The single optical fiber may carry the optical signals simultaneously to one or more network locations. Such network locations may be one or more of a switch, a server, a storage device, etc. As should be appreciated, the system 100 may be capable of communicating with other multi-ASIC systems similar to or the same as the system 100. In this way, a plurality of systems as described herein may form a multi-switch network and may serve as, for example, an Ethernet network for a datacenter.

The present disclosure is directed to a dedicated system solution with multiple optical connectors that may shuffle lambdas (e.g., individual wavelength signals) between the optical connectors 101 and 103. For example, the system may take a pair of input fibers, demultiplex the WDM signals on each input fiber into individual lambdas, distribute the individual lambdas to output connectors, and then multiplex the individual lambdas back into a WDM signal to be transferred over a pair of output fibers. In this way, each fiber line 109 may carry data simultaneously at different wavelengths as described herein.

The system 100 may further comprise one or more light sources (not shown), such as an external light source (ELS). The one or more light sources may be connected to the system 100 or may be embedded in the system 100 itself. The one or more light sources may be external to the system or may be internal to the system. A light source may be capable of outputting light onto one or more optic fibers 109. The light output from the light source may be at a particular wavelength or range of wavelengths. In some embodiments, a separate light source, such as an ELS, may be used to output a particular wavelength of light. Each light source may provide a constant stream of light (e.g., a continuous wave) to one or more electrical-to-optical (E-O) converter(s) in the ASIC package. Each ASIC may modulate a signal onto this light wave. In this way, each ELS may output an optic signal of a different wavelength or range of wavelengths.

As should be appreciated, the signals may be transmitted via any combination of WDM and parallel optics. Using parallel optics, signals may be transmitted using multiple fibers. Using WDM, signals may be transmitted using a single fiber on which multiple signals are multiplexed. A multiplexed signal from an external cable 109 may, for example, comprise two or more signals are multiplexed at different wavelengths. A multiplexed signal may be de-multiplexed into a plurality of signals at distinct wavelengths. The de-multiplexing of the multiplexed signal may in some embodiments be performed at the connectors 101 and 103. In such an embodiment, when a connector 101 or 103 receives a multiplexed signal on an optic fiber 109, the connector 101 or 103 may de-multiplex the signal using, for example, a wavelength de-multiplexer (demux) and distribute the individual wavelength signals to respective connectors 101 or 103.

These signals can be routed to output connectors/fibers with some restrictions (e.g., each output connectors/fibers can take only one signal per wavelength). For example, if there are wavelengths 1, 2, 3, and 4 on connector A and on the same wavelengths (but different signals) on B, these signals may be referred to as A1, A2, A3, A4, B1, B2, B3, and B4. Continuing the example, there are output connectors X, Y, and Z. In one example, signals A1, B2, A3, A4 may be routed to Y; signal B1 may be routed to X; and signals A2, B3, and B4 may be routed to Z. However, signals A1 and B1 can not be routed to the same output.

In other words, a number of groups of wavelengths (e.g., WDM signals) comes in. Each WDM signal has at most one of each lambda (zero of some of the lambdas is also possible). Each lambda in each input can be designated as a subsignal. The shuffle box 110 reorganizes the subsignals, so that the subsignals are grouped differently (e.g., an output WDM signal may contain subsignals from several input signals). Each output signal has one (or zero) of each lambda.

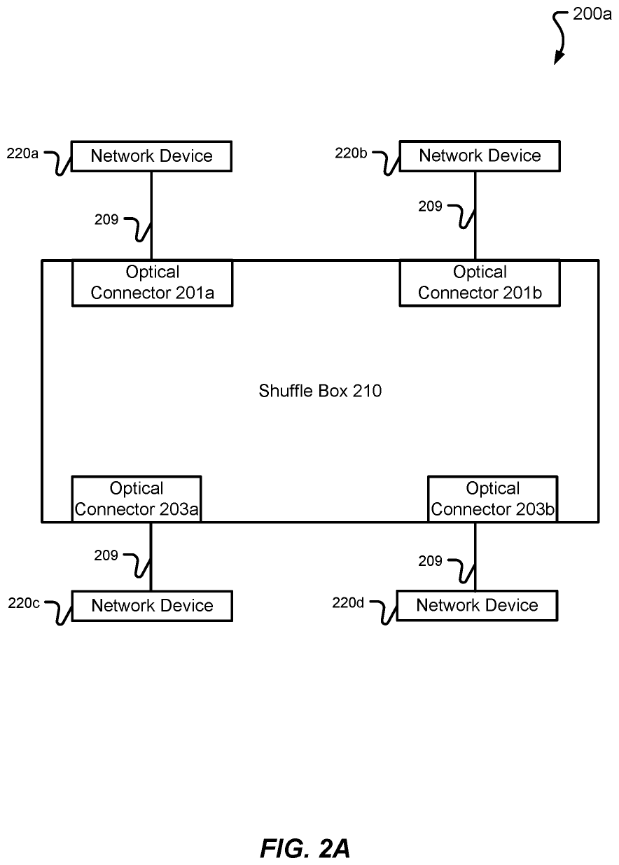

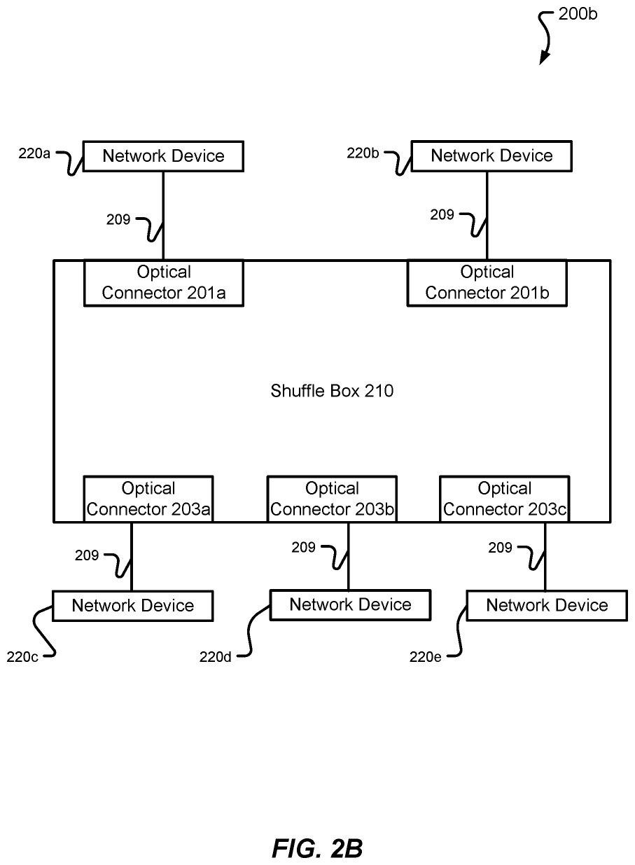

FIG. 2A illustrates an alternative configuration 200a of the shuffle box 210. The cables 209 transmit a signal from respective network devices 220a-b to respective optical connectors 201a-b, each signal comprising wavelengths 1, 2, 3 and 4. The wavelengths 1, 2, 3 and 4 of the signal from the network device 220a may be referred to as A1, A2, A3, and A4; and the wavelengths 1, 2, 3 and 4 from the signal from the network device 220b may be referred to as B1, B2, B3, and B4. The optical connectors 201a-b demultiplex each signal into the individual wavelengths (e.g., lambdas). The shuffle box 210 reorganizes the lambdas, so that the lambdas are grouped differently. In embodiments, the system may include a separate demultiplexer, or the demultiplexing function may be performed by the shuffle box 210.

Each lambda is transferred to an optical connector 203a-b. For example, A1, A2, B1, and B2 are transferred to the optical connector 203a, and A3, A4, and B3, and B4 are transferred to the optical connector 203b. It should be appreciated that other combinations of lambdas are possible, as long as each optical connector 203a-b does not receive more than one lambda of the same wavelength (e.g., A1 and B1 can not be transferred to the same output connector). The optical connectors 203a-b multiplex respective lambdas into a wavelength division multiplexing signal. In embodiments, the system may include a separate multiplexer, or the multiplexing function may be performed by the shuffle box 210. In embodiments, the network devices 220a-b are in a different layer of the network than the network devices 220c-d.

Referring to FIG. 2B, the shuffle box 210 distributes lambdas between the optical connectors 201a-b and 203a-c. Respective wavelength division multiplexing signals are transmitted from respective network devices 220a-e via cables 209. For example, A1, A2, A3, and A4 from the network device 220a; and B1, B2, B3, and B4 from the network device 220b. The shuffle box 110 shuffles the signals A1, A2, A3, A4, B1, B2, B3, and B4 and distributes them to the optical connectors 203a-c.

In one example, signals A1, B2, and A3 may be routed to optical connector 203a; signals A4 and B1 may be routed to optical connector 203b; and signals A2, B3, and B4 may be routed to optical connector 203c. The optical connectors 203a-c multiplex their respective lambdas into respective wavelength division multiplexing signals for the network devices 220c-e.

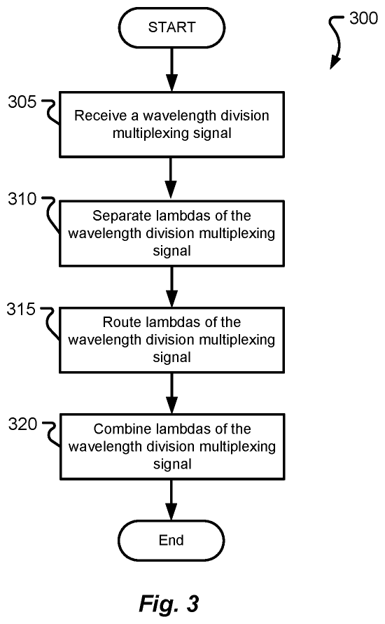

FIG. 3 illustrates an example of a process flow 300 for distributing individual wavelength signals to different destinations in accordance with aspects of the present disclosure. In some examples, process flow 300 may implement aspects of shuffle box 110 described with reference to FIGS. 1-2B and 4.

In the following description of the process flow 300, the operations may be performed in a different order than the order shown, or the operations may be performed in different orders or at different times. Certain operations may also be left out of the process flow 300, or other operations may be added to the process flow 300.

In step 305, a wavelength division multiplexing signal is received. For example, an input connector 101 receives a wavelength division multiplexing signal from a network device 120 over a cable 109.

In step 310, lambdas of the wavelength division multiplexing signal are separated. For example, the shuffle box 110 may demultiplex the wavelength division multiplexing signal.

In step 315, each lambda of the wavelength division multiplexing signal is routed to an output connector. For example, the shuffle box 110 routes each lambda of the wavelength division multiplexing signal to an output optical connector 103.

In step 320, the received lambdas are combined into a wavelength division multiplexing signal. For example, each output connector 103 combines its respective lambdas into a wavelength division multiplexing signal.

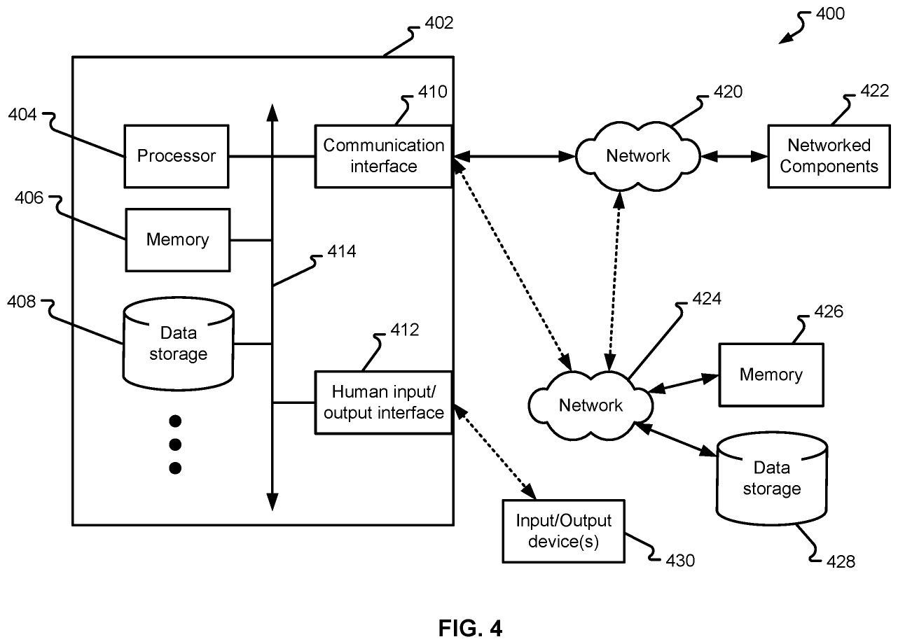

FIG. 4 depicts device 402 in system 400 in accordance with embodiments of the present disclosure. Device 402 may be an example of the network device 120.

The components are variously embodied and may comprise processor 404. The term “processor,” as used herein, refers exclusively to electronic hardware components comprising electrical circuitry with connections (e.g., pin-outs) to convey encoded electrical signals to and from the electrical circuitry. Processor 404 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 414, executes instructions, and outputs data, again such as via bus 414.

In other embodiments, processor 404 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 404 is a non-transitory computing device (e.g., electronic machine comprising circuitry and connections to communicate with other components and devices). Processor 404 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 404). Processor 404 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 404, device 402 may utilize memory 406 and/or data storage 408 for the storage of accessible data, such as instructions, values, etc. Communication interface 410 facilitates communication with components, such as processor 404 via bus 414 with components not accessible via bus 414. Communication interface 410 may be embodied as a network port, card, cable, or other configured hardware device. Additionally, or alternatively, human input/output interface 412 connects to one or more interface components to receive and/or present information (e.g., instructions, data, values, etc.) to and/or from a human and/or electronic device. Examples of input/output devices 430 that may be connected to input/output interface include, but are not limited to, keyboard, mouse, trackball, printers, displays, sensor, switch, relay, speaker, microphone, still and/or video camera, etc. In another embodiment, communication interface 410 may comprise, or be comprised by, human input/output interface 412. Communication interface 410 may be configured to communicate directly with a networked component or utilize one or more networks, such as network 420 and/or network 424. Input/output device(s) 430 may be accessed by processor 404 via human input/output interface 412 and/or via communication interface 410 either directly, via network 424 (not shown), via network 420 alone (not shown), or via networks 424 and 420 (not shown).

Networks 420 and 424 may be a wired network (e.g., Ethernet), wireless (e.g., Wi-Fi, Bluetooth, cellular, etc.) network, or combination thereof and enable device 402 to communicate with networked component(s) 422 (e.g., automation system). In other embodiments, networks 420 and/or 424 may be embodied, in whole or in part, as a telephony network (e.g., public switched telephone network (PSTN), private branch exchange (PBX), cellular telephony network, etc.).

Components attached to network 424 may include memory 426 and data storage 428. For example, memory 426 and/or data storage 428 may supplement or supplant memory 406 and/or data storage 408 entirely or for a particular task or purpose. For example, memory 426 and/or data storage 428 may be an external data repository (e.g., server farm, array, “cloud,” etc.) and allow device 402, and/or other devices, to access data thereon. Each of memory 406 and data storage 408, memory 426, data storage 428 comprise a non-transitory data storage comprising a data storage device.

Although example embodiments have been shown and described with respect to systems having specific types of elements, numbers of elements, sizes elements, and/or shapes of elements, it should be appreciated the disclosed concepts are not limited thereto and that fewer, additional, and/or different types of elements, numbers of elements, sizes elements, and/or shapes of elements are within the scope of the disclosed concepts. In addition, the connectors described herein may be implemented as female and/or male connectors as desired.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the disclosed concepts may be otherwise variously embodied and employed, and that the appended claims are intended to be construed to include such variations, except as limited by the prior art.

It should be appreciated that the disclosed concepts cover any embodiment in combination with any one or more other embodiments, any one or more of the features disclosed herein, any one or more of the features as substantially disclosed herein, any one or more of the features as substantially disclosed herein in combination with any one or more other features as substantially disclosed herein, any one of the aspects/features/embodiments in combination with any one or more other aspects/features/embodiments, use of any one or more of the embodiments or features as disclosed herein. It is to be appreciated that any feature described herein can be claimed in combination with any other feature(s) as described herein, regardless of whether the features come from the same described embodiment.

It will be appreciated that the embodiments described above are cited by way of example, and that the present invention is not limited to what has been particularly shown and described hereinabove. Rather, the scope of the present invention includes both combinations and sub combinations of the various features described hereinabove, as well as variations and modifications thereof which would occur to persons skilled in the art upon reading the foregoing description and which are not disclosed in the prior art.

What is claimed is:

1. A system for distributing individual wavelength signals to different destinations, the system comprising:
three or more optical connectors, wherein fibers connected to the three or more optical connectors carry a plurality of wavelength signals; and
a device that routes a first optical signal having a first wavelength from a first optical connector to a second optical connector.

2. The system of claim 1, wherein the device routes a second optical signal having a second wavelength from the first optical connector to a third optical connector.

3. The system of claim 2, wherein the first wavelength is different from the second wavelength.

4. The system of claim 1, wherein the three or more optical connectors comprise a Lucent Connector (LC).

5. The system of claim 1, wherein the first optical connector connects to a first network device and the second optical connector connects to a second network device.

6. The system of claim 5, wherein the first network device is in a first layer of a network and the second network device is in a second layer of the network that is different from the first layer of the network.

7. The system of claim 5, wherein the first network device and the second network device comprise a switch.

8. The system of claim 1, wherein the plurality of wavelength signals comprise a wavelength division multiplexing (WDM) signal comprising four different wavelengths signals.

9. The system of claim 1, wherein the second optical connector multiplexes at least two optical signals of different wavelengths.

10. A method of distributing portions of a wavelength division multiplexing (WDM) signal to different destinations, the method comprising:
receiving via a first optical connector a WDM signal from a first network device, wherein the WDM signal comprises a plurality of wavelength signals;
separating via an optical demultiplexer the WDM signal into the plurality of wavelength signals; and
routing and multiplexing via a device a first wavelength signal having a first wavelength and a second wavelength signal having a second wavelength from the first optical connector to a second optical connector, and a third wavelength signal having a third wavelength and a fourth wavelength signal having a fourth wavelength from the first optical connector to a third optical connector.

11. The method of claim 10, wherein the first optical connector, the second optical connector, and the third optical connector comprise a Lucent Connector (LC).

12. The method of claim 10, wherein the first optical connector connects to the first network device and the second optical connector connects to a second network device, wherein the first network device is in a first layer of a network, and wherein the second network device is in a second layer of the network that is different from the first layer.

13. The method of claim 12, wherein the first network device and the second network device comprise a network switch.

14. The method of claim 10, wherein the WDM signal comprises four different wavelength signals.

15. A device for distributing individual wavelength signals to different destinations, the device comprising:
three or more optical connectors, wherein fibers connected to the three or more optical connectors carry a plurality of wavelength signals; and
a control that routes a first optical signal having a first wavelength from a first optical connector to a second optical connector.

16. The device of claim 15, wherein:
the control routes a second optical signal having a second wavelength from the first optical connector to a third optical connector.

17. The device of claim 15, wherein the three or more optical connectors comprise a Lucent Connector (LC).

18. The device of claim 15, wherein the first optical connector connects to a first network device and the second optical connector connects to a second network device, and wherein the first network device is in a first layer of a network and the second network device is in a second layer of the network that is different from the first layer of the network.

19. The device of claim 18, wherein the first network device and the second network device comprise a switch.

20. The device of claim 15, wherein the plurality of wavelength signals comprise a wavelength division multiplexing (WDM) signal comprising four different wavelengths signals.
